(19) United States
(12) Patent Application Publication
(10) Pub. No.: US 2025/0384337 A1
(43) Pub. Date: Dec. 18, 2025

(54) ON-DEVICE NEURAL NETWORK TRAINING FOR EDGE DEVICES

(71) Applicant: QUALCOMM Incorporated, San Diego, CA (US)

(72) Inventors: Chen FENG, Richmond Hill (CA); Shaojie ZHUO, Richmond Hill (CA); Zhaocong YUAN, Toronto (CA); Ramchalam KINATTINKARA RAMAKRISHNAN, North York (CA); Xiaopeng ZHANG, North York (CA)

(21) Appl. No.: 18/747,214

(22) Filed: Jun. 18, 2024

(51) Int. Cl. G06N 20/00

(52) U.S. Cl. CPC G06N 20/00

(57) ABSTRACT

A processor-implemented method for a fixed-point, forward-forward on-device model training/adaptation is described. The processor-implemented method includes running a first forward call according to positive perturbation parameters sampled from a random perturbation vector that follows standard, normal distribution. The processor-implemented method also includes running a second forward call according to negative perturbation parameters sampled from the random perturbation vector. The processor-implemented method further includes computing forward gradients according to the random perturbation vector and a directional derivative based on the first forward call and the second forward call. The processor-implemented method also includes updating weights of the on-device model according to the forward gradients.

### FIELD OF THE DISCLOSURE

Aspects of the present disclosure relate to artificial neural networks, and more specifically, to on-device training for edge devices.

### BACKGROUND

An artificial neural network, which may include an interconnected group of artificial neurons, may be a computational device or may represent a method to be performed by a computational device. Artificial neural networks may have corresponding structure and/or function in biological neural networks. Artificial neural networks, however, may provide useful computational techniques for certain applications, in which traditional computational techniques may be cumbersome, impractical, or inadequate. Because artificial neural networks may infer a function from observations, such networks may be useful in applications where the complexity of the task and/or data makes the design of the function burdensome using conventional techniques.

Continuously adapting pre-trained models to personalized data on memory constrained devices (e.g., edge devices) is essential for model customization and user privacy. Unfortunately, model training and fine-tuning for adapting pre-trained models to personalized data through traditional backpropagation is prohibitive. Adapting pre-trained models to personalized data through traditional backpropagation involves a large memory footprint for storing intermediate activations, which is prohibitive for memory constrained devices (e.g., edge devices with limited memory). Additionally, most existing low power neural processing engines and microcontrollers are optimized as fixed-point inference accelerators, without training capabilities. An on-device training process for memory constrained devices is desired.

### SUMMARY

A processor-implemented method for a fixed-point, forward-forward on-device model training/adaptation is described. The processor-implemented method includes running a first forward call according to positive perturbation parameters sampled from a random perturbation vector that follows standard, normal distribution. The processor-implemented method also includes running a second forward call according to negative perturbation parameters sampled from the random perturbation vector. The processor-implemented method further includes computing forward gradients according to the random perturbation vector and a directional derivative based on the first forward call and the second forward call. The processor-implemented method also includes updating weights of the on-device model according to the forward gradients.

An apparatus is described, including at least one memory and at least one processor coupled to the at least one memory. The at least one processor is configured to run a first forward call according to positive perturbation parameters sampled from a random perturbation vector that follows standard, normal distribution. The at least one processor is also configured to run a second forward call according to negative perturbation parameters sampled from the random perturbation vector. The at least one processor is further configured to compute forward gradients according to the random perturbation vector and a directional derivative based on the first forward call and the second forward call. The at least one processor is also configured to update weights of the on-device model according to the forward gradients. The processor has a floating point or fixed-point compute engine.

This has outlined, broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for conducting the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a central processing unit (CPU), configured for a fixed-point, forward-forward on-device model training in accordance with certain aspects of the present disclosure.

FIGS. 2A, 2B, and 2C are diagrams illustrating a neural network, in accordance with various aspects of the present disclosure.

FIG. 2D is a diagram illustrating an exemplary deep convolutional network (DCN), in accordance with various aspects of the present disclosure.

FIGS. 3A-3C are block diagrams illustrating a fixed-point, forward-forward on-device model training, in accordance with various aspects of the present disclosure.

FIG. 4 illustrates an on-device quantized training process that utilizes (i) weights perturbation, (ii) forward-forward calls, and (iii) weight updating via a quantized stochastic gradient descent (SGD) process, according to various aspects of the present disclosure.

FIG. 5 is a flow diagram illustrating an example processor-implemented method for a fixed-point, forward-forward on-device model training, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. Any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although aspects are described, many variations and permutations of these aspects fall within the scope of the disclosure. Although some benefits and advantages of the preferred aspects are mentioned, the scope of the disclosure is not intended to be limited to benefits, uses or objectives. Rather, aspects of the disclosure are intended to be universally applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Continuously adapting pre-trained models to personalized data on memory constrained devices (e.g., edge devices) is essential for model customization and user privacy. Unfortunately, model training and fine-tuning for adapting pre-trained models to personalized data through traditional backpropagation is prohibitive with traditional methodologies. Adapting pre-trained models to personalized data through traditional backpropagation involves a large memory footprint for storing intermediate activations. This large memory footprint from storing intermediate activations, however, is prohibitive for memory constrained devices (e.g., edge devices with limited memory). Additionally, most existing low power neural processing engines and microcontrollers are optimized as fixed-point inference accelerators, without training capabilities. An on-device training process with reduced memory requirements is desired. Such training process may be used for memory constrained devices, or for other devices in which a reduced memory requirement (as compared to traditional methodologies) is desired.

Various aspects of the present disclosure are directed to model training (e.g., on resource constrained embedded devices) by utilizing a zero-order stochastic gradient descent (SGD) process, in which gradients are estimated using two forward passes through weight perturbations without storing intermediate activations. Other complex optimizers (e.g., Adam) may be applied on top of the estimated forward gradient for updating weights. These aspects of the present disclosure mitigate the challenge of noisy forward gradient estimation by implementing the direction of the projected gradient, rather than its magnitude in some configurations. This allows on-device model fine-tuning without increasing the memory footprint which would be required for inference, and also preserves accuracy. Additionally, training with forward gradients through two forward calls avoids a large memory footprint specified by backpropagation implementations. This zero-order SGD process beneficially enables local adaptation of an on-device model for continuous learning and model personalization.

In various aspects of the present disclosure a processor-implemented method for a fixed-point, forward-forward on-device model training includes running a first forward call according to positive perturbation parameters sampled from a random perturbation vector that follows standard normal distribution. The processor-implemented method also includes running a second forward call according to negative perturbation parameters sampled from the random perturbation vector. The processor-implemented method further includes computing a forward gradient according to the random perturbation vector and a directional derivative based on the first forward call and the second forward call. The processor-implemented method also includes updating weights of an on-device model according to the forward gradient.

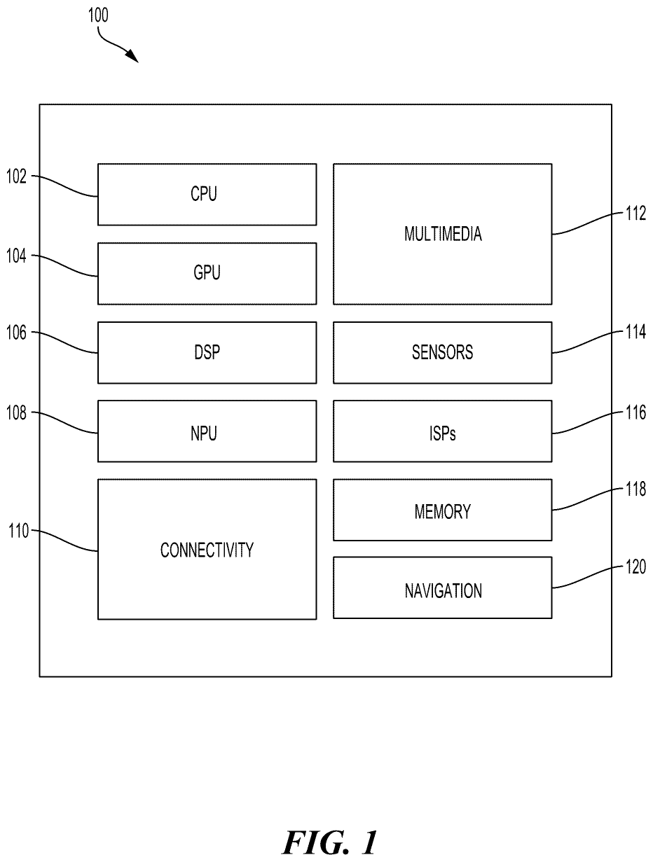

FIG. 1 illustrates an example implementation of a system-on-a-chip (SOC) 100, which may include a central processing unit (CPU) 102 or a multi-core CPU configured for a fixed-point, forward-forward on-device model training. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the NPU 108 may include code to run a first forward call according to positive perturbation parameters sampled from a random perturbation vector that follows standard, normal distribution. The NPU 108 may also include code to run a second forward call according to negative perturbation parameters sampled from the random perturbation vector. The NPU 108 may further include code to compute forward gradients according to the random perturbation vector and a directional derivative based on the first forward call and the second forward call. The NPU 108 may also include code to update weights of the on-device model according to the forward gradients.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are like what a human engineer might design, but through training. Furthermore, a deep network may learn to represent and recognize new types of features that a human might not have considered.

A deep learning architecture may learn a hierarchy of features. If presented with visual data, for example, the first layer may learn to recognize simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in diverse ways to recognize cars, trucks, and airplanes.

Neural networks may be designed with a variety of connectivity patterns. In feed-forward networks, information is passed from lower to higher layers, with each neuron in each layer communicating to neurons in higher layers. A hierarchical representation may be built up in successive layers of a feed-forward network, as described above. Neural networks may also have recurrent or feedback (also called top-down) connections. In a recurrent connection, the output from a neuron in each layer may be communicated to another neuron in the same layer. A recurrent architecture may be helpful in recognizing patterns that span more than one of the input data chunks that are delivered to the neural network in a sequence. A connection from a neuron in each layer to a neuron in a lower layer is called a feedback (or top-down) connection. A network with many feedback connections may be helpful when the recognition of a high-level concept may aid in discriminating the low-level features of an input.

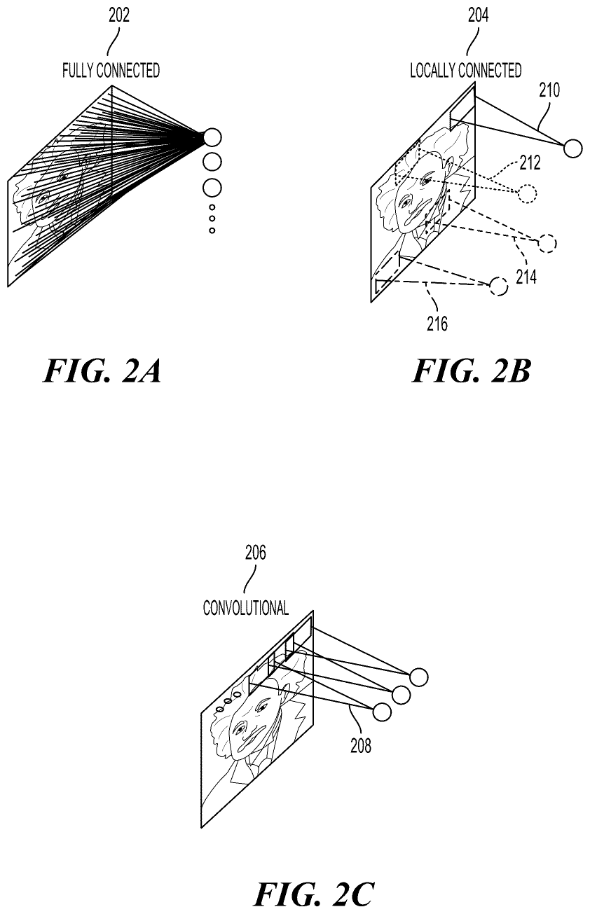

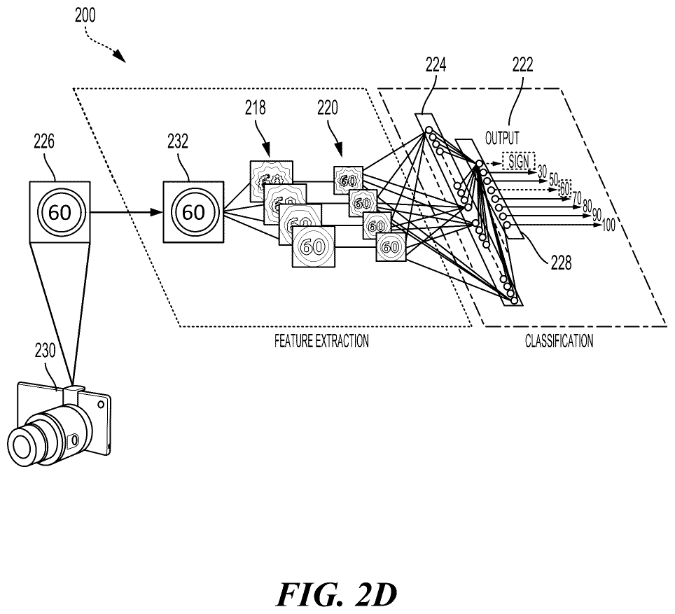

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in each region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “backpropagation” as it involves a “backward pass” through the neural network. Unfortunately, model training and fine-tuning for adapting pre-trained models to personalized data through traditional backpropagation is prohibitive. Adapting pre-trained models to personalized data through traditional backpropagation involves a large memory footprint for storing intermediate activations. This large memory footprint from storing intermediate activations, however, is prohibitive for memory constrained devices (e.g., edge devices with limited memory).

In practice, the gradient of weights may be calculated over a small number of examples, so that the calculated gradient approximates the true gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images (e.g., the speed limit sign of the image 226 or another speed limit sign or other image) and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier. Additionally, a recurrent network, a transformer-based network, or other like neural network may be trained in an unsupervised manner and may serve as feature extractors.

DCNs are networks of convolutional networks, configured with additional pooling and normalization layers. DCNs as well as transformer-based models have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max (0, x). Values from adjacent neurons may be further pooled, which corresponds to down sampling, and may provide additional local invariance and dimensionality reduction. Normalization, which corresponds to whitening, may also be applied through lateral inhibition between neurons in the feature map. Although described with reference to a DCN, the various aspects of the present disclosure are not limited to DCNs, as transformer-based model and other like neural network models are contemplated.

Continuously adapting pre-trained models to personalized data on memory constrained devices (e.g., edge devices) is essential for model customization and user privacy. Unfortunately, model training and fine-tuning for adapting pre-trained models to personalized data through traditional backpropagation is prohibitive. Adapting pre-trained models to personalized data through traditional backpropagation involves a large memory footprint for storing intermediate activations. This large memory footprint from storing intermediate activations, however, is prohibitive for memory constrained devices (e.g., edge devices with memory under one MB). Additionally, most existing low power neural processing engines and microcontrollers are optimized with a fixed-point inference accelerator, without training capabilities. In addition, training with traditional backpropagation is limited to operation with differentiable loss; however, there are several use cases and applications involving a non-continuous loss, which prohibits training utilizing backpropagation. Consequently, an on-device training process with reduced memory requirements is desired. Such training process may be used for memory constrained devices, or for other devices in which it is desired to conduct on-device training without requiring the memory footprint of traditional backpropagation.

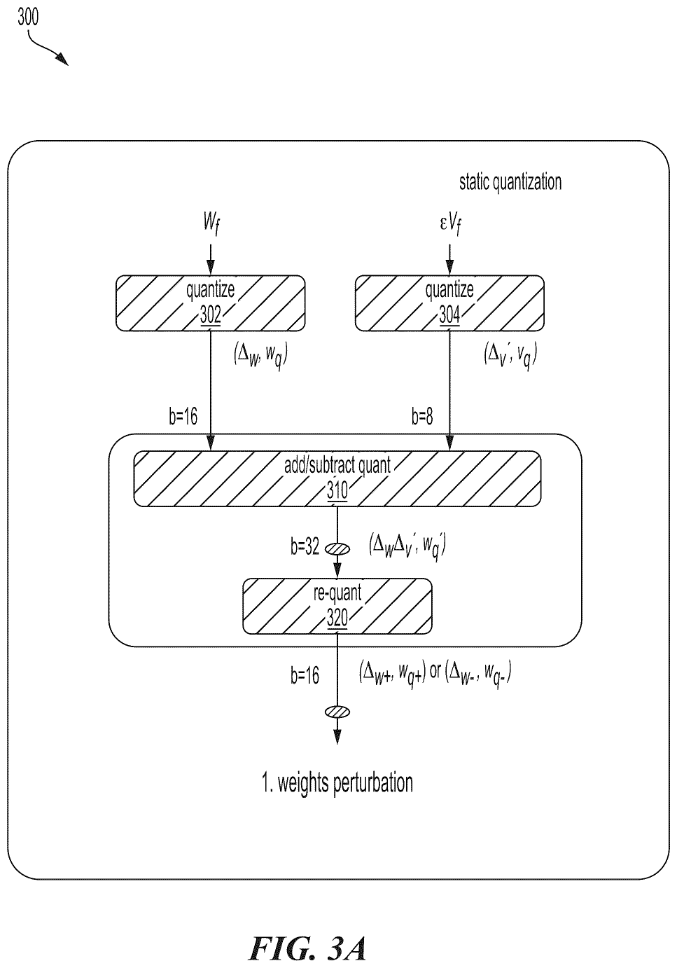

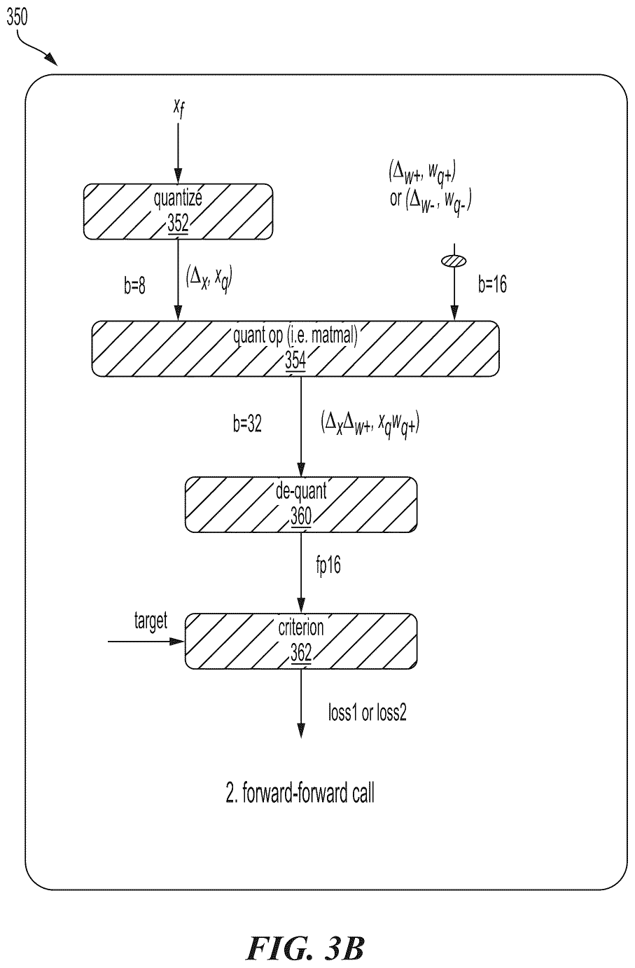

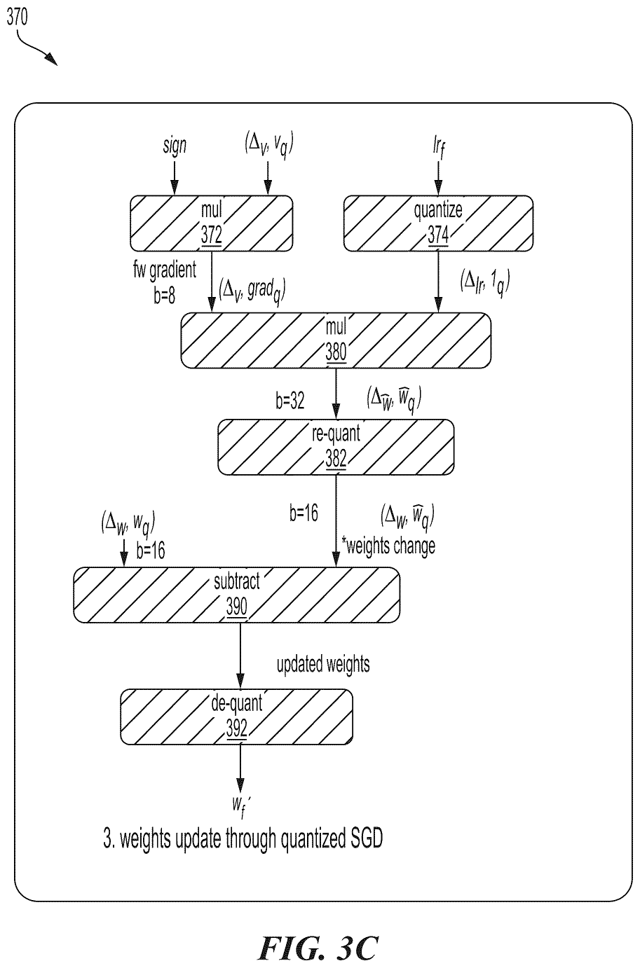

Various aspects of the present disclosure are directed to model training (e.g., on resource constrained embedded devices) by utilizing a zero-order stochastic gradient descent (SGD) process, in which gradients are estimated using two forward passes through weight perturbations without storing intermediate activations. These aspects of the present disclosure mitigate the challenge of noisy forward gradient estimation by implementing the direction of the projected gradient, rather than its magnitude in some configurations. This allows stable on-device model fine-tuning without increasing the memory footprint which would be required for inference, and also preserves accuracy. Additionally, training with forward gradients through two forward calls avoids a large memory footprint associated with backpropagation implementations. This zero-order SGD process beneficially enables local adaptation of an on-device model for continuous learning and model personalization, for example, as shown in FIGS. 3A-3C.

FIGS. 3A-3C are block diagrams illustrating a fixed-point, forward-forward on-device model training, in accordance with various aspects of the present disclosure. The methodology shown in FIGS. 3A-3C is based on the following definitions, theorem, and forward-forward gradient descent process:
Definition: Given a function ƒ: [symbol] → [symbol] and model parameters θ∈ [symbol] , with perturbation vector v∈ [symbol] , the forward gradient g: [symbol] → [symbol] is defined as a directional derivative of ƒ:

$$g ( θ ) = ( ∇ f ( θ ) \cdot v ) v \qquad ( 1 )$$

Theorem: The forward gradient g(θ) is an unbiased estimator of the gradient ∇ƒ(θ) when v˜ [symbol] (0,1),

$$E ( g ( θ ) ) = ∇ f ( θ ) \qquad ( 2 )$$

where [symbol] (0,1) represents for standard normal distribution, with zero mean and one as standard deviation. The random perturbation v follows but not restricted to standard normal distribution. Other distributions such as Binomial distribution also applied.

TABLE I
Forward Gradient Descent Process

Require:

| * | Parameters θ_{q} ∈ I^{d} | | | |
|---|---|---|---|---|
| * | Loss [symbol] : R^{d} → R | | | |
| * | learning rate schedule {ηₜ} | | | |
| * | Step budge T, perturbation scale ε, batch size B | | | |
| for | for t = 1, .... , T do | | | |
| \| | | Sample batch B ⊂ D | | |
| \| | | Sample random seed s , generate perturbation vₜ~ [symbol] (0, I), vₜ ∈ [symbol] , | | |
| \| | | and quantize the value to (Δᵥ, v_{q}), v_{q} ∈ I^{d} | | |
| \| | | * | θ_{q+} ← perturbateParameters(θ_{q}, ε_{q}, v_{q}, Δᵥ) | [symbol] pertubate in positive direction |
| \| | | | Run forward call (l₊ ← [symbol] (θ_{q+}; B) | |
| \| | | * | θ_{q~} ← perturbateParameters(θ_{q}, −2ε_{q}, v_{q}, Δᵥ) | [symbol] pertubate in negative direction |
| \| | | | Run forward call l₋ ← [symbol] (θ_{q-}; B) | |

| | | |
|---|---|---|
| \| | g_{q} = ∇ᵥ_{ₜ} l(θ) · v ← sign((l₊ − l₋)2ε) · v_{q} | [symbol] quantized forward gradient |
| \| | θ_{q} ← perturbateParameters(θ_{q}, ε_{q}, v_{q}, Δᵥ) | [symbol] reset weights to original position |
| \| | $for {θ}_{q}^{i} ∈ {θ}_{q} do$ | [symbol] parameter update |

| | |
|---|---|
| \| | \| ${θ}_{q}^{i} ← {θ}_{q}^{i} - [ {η}_{i} , {Δ}_{v} / {Δ}_{{θ}_{i}} ] \cdot {g}_{q}$ |
| | end |

end
Subroutine: mapping perturbate parameters in quantized space (θ_{q}, ε_{q}, v_{q}, Δᵥ)

$for {θ}_{q}^{i} ∈ {θ}_{q} do$
| ${θ}_{q}^{i} ← [ {Δ}_{v} ( {θ}_{q}^{i} \cdot [ 1 / {Δ}_{v} ] + {ε}_{q} + {v}_{q} ) ] , where {ε}_{q} = [ ε / {Δ}_{{θ}_{i}} ]$
end
return θ_{q}

As shown Table I, the forward gradient descent process begins by sampling a random perturbation vector vₜ˜ [symbol] (0, I), which has parameters of a same size. Additionally, a forward call is run twice with positive and negative perturbations. Weights perturbation in the quantized space is shown in the subroutine, where (θ_{q}, ε_{q}, v_{q}) are the quantized value of (θ, ε, vₜ), and Δᵥ, Δ_{θ} represents for the quantization scaling factor of vₜ and θ. The directional derivative obtained, ∇ᵥ_{ₜ}l(θ), is computed as a scalar value based on the forward calls and a perturbation scale (2ε). A parameter update computes the forward gradient (g(θ)) by multiplying a sign of the directional derivative with vector v_{q}. According to various aspects of the present disclosure, Table I illustrates an overall workflow of the forward gradient descent process, which is in floating-point precision.

FIGS. 3A-3C illustrate an implementation of the forward gradient descent process of Table I in a fixed-point (FP) accelerator engine, according to various aspects of the present disclosure. FIG. 3A shows a static quantization for a weight perturbation process 300, in which a random perturbation v_{θ} and the perturbation scale ε are mapped together to provide a mapped perturbation (εv_{ƒ}). Additionally, the parameter θ in Table I is represented as a weight w_{ƒ} in FIG. 3A, which corresponds to the parameters in a network in which an update is begin performed. In this example, the weight w_{ƒ} is fed to a first quantize block 302 that generates quantized weight values (Δ_{w}, w_{q}) in 16-bit format. Similarly, the mapped perturbation value εv_{ƒ} is fed to a second quantize block 304, which generates quantized perturbation values (Δᵥ′, v_{q}) in 8-bit format to provide a 16-bit weight (W16) 8-bit activation (A8) (W16A8) quantization format.

As further illustrated in FIG. 3A, quantized weight values (Δw, w_{q}) and the quantized perturbation values (Δᵥ′, v_{q}) are fed to an add/subtract quantization block 310. In this example, the add/subtract quantization block 310 generates output values (Δ_{w}Δᵥ′, w_{q}′) in 32-bit format that are fed to a re-quantize block 320 to generate weights perturbated in a positive direction (Δ_{w+}, w_{q+}) and weights perturbated in a negative direction (Δ_{w-}, w_{q-}) in 8-bit format. For random perturbation, various aspects of the present disclosure utilize momentum to guide the sampling. For example, during the initial training stage, random perturbations are utilized. As training progresses, a history of the momentum (z) is incorporated to guide the new sampling. This variation may involve additional memory to store the perturbations. Nevertheless, the add-on memory is still in the order of the updated parameter size, which is significantly less than an activation size.

FIG. 3B illustrates a forward-forward call process 350 to generate a first loss value (loss1) and a second loss value (loss2), according to various aspects of the present disclosure. FIG. 3B provides an example of a process for performing integer multiplication as part of the forward-forward call process 350. As shown in FIG. 3B, a model input (x_{ƒ}) is initially in floating point precision and fed to an input quantize block 352 to generate quantized model input values (Δₓ, x_{q}) in 8-bit format. The model input values (Δₓ, x_{q}) or the weights perturbated in a positive direction (Δ_{w+}, w_{q+}) and weights perturbated in a negative direction (Δ_{w-}, w_{q-}) are fed to a quantization operation block 354. In various aspects of the present disclosure, the quantization operation block 354 is implemented using a 32-bit accumulator configured to perform a matrix multiplication (matmul) operation.

In this example, the quantization operation block 354 generates quantized values (ΔₓΔ_{w+}, x_{q}w_{q+}) in 32-bit format, in which ΔₓΔ_{w+} represent a scale and x_{q}w_{q+} represent a value. These quantized values are fed to a de-quantize block 360 to generate an output value in 16-bit floating point (fp16) format. This fp16 output value is fed to a criterion block 362 along with a target value to generate a first loss value (loss1) and a second loss value (loss2). Alternatively, the de-quantize block 360 may be removed with the criterion block 362 directly performed in fixed-point precision and the output loss (e.g., loss1, loss2) generated as fixed point values.

FIG. 3B illustrates a forward-forward call process 350 for gradient calculation through two forward calls, one with weights perturbated in a positive direction (Δ_{w+}, w_{q+}) and one with weights perturbated in a negative direction (Δ_{w-}, w_{q-}). In various aspects of the present disclosure, multiple loops of the forward-forward call process 350 are run to average the gradient calculation, which provides a more stable gradient. Additionally, a kernel-wise normalization is performed after the gradient is calculated through the forward-forward call process 350. For example, a scaling factor is applied to the gradient (e.g., prior to multiplication operation in a weights update process, for example, as shown in FIG. 3C). This scaling factor is kernel dependent.

Various aspects of the present disclosure introduce an ‘nFold’ training parameter to average the forward gradient from multiple runs of the forward-forward call process 350. Additionally, a sharpness-aware mechanism is proposed to dynamically schedule the ‘nFold’ parameter during the training process, such that the ‘nFold’ training parameter represents a dynamic schedule training parameter for performing a loss landscape sharpness analysis. For example, a larger loss difference magnitude indicates a sharper loss landscape, and a larger ‘nFold’ value is specified in this case for gradient estimation. Determining the ‘nFold’ involves a balance between training speed and accuracy. For example, setting the ‘nFold’ value (e.g., nFold=3), means that the forward-forward call process 350 is run three times, each with an independent perturbation, and the gradient is averaged before updating the weights. In operation, a higher ‘nFold’ increases the training time, however, setting the ‘nFold’ value involves a balance of time and accuracy.

Additionally, various aspects of the present disclosure provide a sparse update for determining a subset of the weights selected from the network for updating. Instead of updating all the parameters in the network, the sparse update selects desired weights for updating. For example, sparse updating may include pruning by top-k magnitude, randomized pruning, pruning values beyond a specified threshold, and the like, to determine the weights selected from the network for updating. Beneficially, sparsity coupled with forward-forward training enables up to a substantial (e.g., 90%) reduction in the trainable parameters' size with minor decreases in accuracy, as well as slight improvements in convergence speed. This sparse update reduces the number of training parameters, resulting in a reduced training time to update network weights, for example, as shown in FIG. 3C.

FIG. 3C illustrates a weights update process 370 through quantized stochastic gradient descent, according to various aspects of the present disclosure. As shown in FIG. 3C, a sign of loss difference through two forward calls and quantized perturbation values (Δᵥ, v_{q}) are fed to a first multiplication block 372 to generate a forward gradient (Δᵥ, grad_{q}) in 8-bit format. Additionally, a learning rate value (lr_{ƒ}) is fed to an input quantize block 374 to generate quantized loss values (Δₗᵣ, 1_{q}) in 8-bit or 16-bit format. The quantized learning rate values (Δₗᵣ, 1_{q}) and the forward gradient (Δᵥ, grad_{q}) are fed to a second multiplication block 380 to compute weight change values ( [symbol] , ŵ_{q}) in 32-bit format. The weight change values ( [symbol] , ŵ_{q}) are fed to a re-quantize block 382 to generate quantized weight change values (Δ_{w}, [symbol] ) in 16-bit format.

According to various aspects of the present disclosure, quantized weight values (Δ_{w}, w_{q}) and the quantized weight change values (Δ_{w}, [symbol] ) are fed to a subtraction block 390 to generate an updated weight. The updated weights are directly fed back through the weight perturbation process 300 for a next training iteration. After the training process, quantized weights are exported to quantized model for inferencing. The weights can be fed to a de-quantize block 392 to generate updated weights (w_{ƒ}′) in float precision for float model update, or further analysis. In this example, the de-quantize block 392 is optional. For example, for a quantized model update, the de-quantize block 392 is completely removed from a product point of view. Nevertheless, if both a float and quantized model are maintained, the de-quantize block 392 is utilized to dequantize the weights back to float precision.

Various aspects of the present disclosure contemplate modifications/variants to the zero-order, weights update process 370 in signal processing for quantization-friendly designs. For example, using the sign of loss difference (instead of the actual value) from multiple forward calls enables smoothing and stabilizing of the noisy gradient estimation. This design is also quantization-friendly, constraining the gradient range for quantization. In various aspects of the present disclosure, kernel-wise normalization occurs prior to weights updating. The change of the weights after each iteration involves re-scaling based on the norm of the weight values:

$$( {w}_{f}^{′} = {lr}_{f} * sign ( loss1 - loss2 ) * z / {‖ z ‖}^{*} ‖ {w}_{f} ‖ ) , \qquad ( 3 )$$

in which z refers to perturbation momentum and lr_{ƒ} represent a learning rate value.

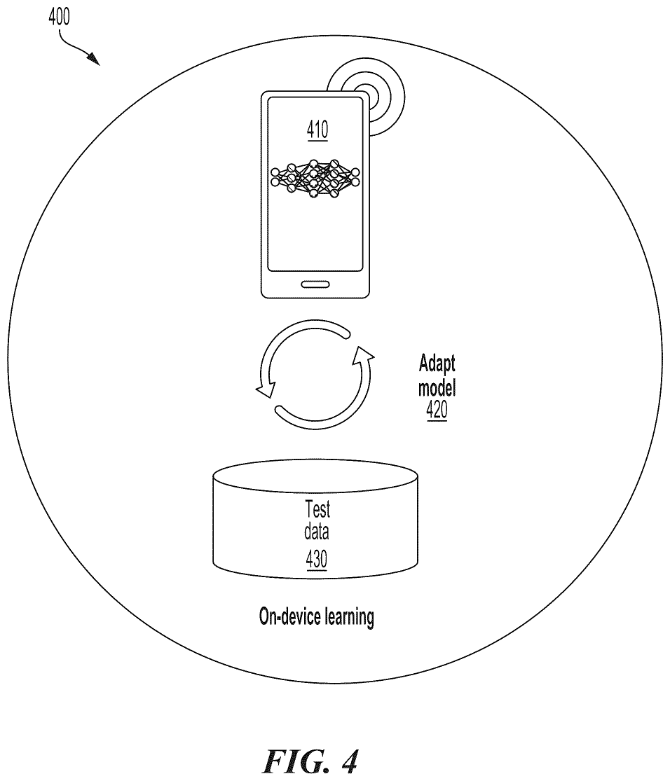

FIG. 4 illustrates an on-device quantized training process 400 that utilizes (i) weights perturbation, (ii) forward-forward calls, and/or (iii) weight updating via quantized stochastic gradient descent (SGD), according to various aspects of the present disclosure. As shown in FIG. 4, on-device learning is performed by a memory constrained device 410 in which model adaption 420 is performed using test data 430. The test data 430 involve personalized data purely stored on-device, which enables on-device training without requiring the memory footprint of traditional backpropagation. In various aspect of the present disclosure, the model adaption 420 performs on-device quantized training utilizing the test data 430, including (i) weights perturbation, (ii) forward-forward calls, and/or (iii) weight updating via quantized SGD.

The proposed quantized forward-forward on-device model training and adaptation is different from traditional back propagation. Rather, various aspects of the present disclosure utilize forward gradients that are calculated from multiple forward calls for weight adaptation, which avoids storage of intermediate activations and reduces memory requirements (e.g., to enable use on memory constrained devices, such as edge devices). Consequently, memory consumption for implementing quantized forward-forward on-device model training and adaptation remains at the same level for model training and inferencing. The memory reduction is substantial (e.g., at least 10×) relative to memory storage specifications for backpropagation.

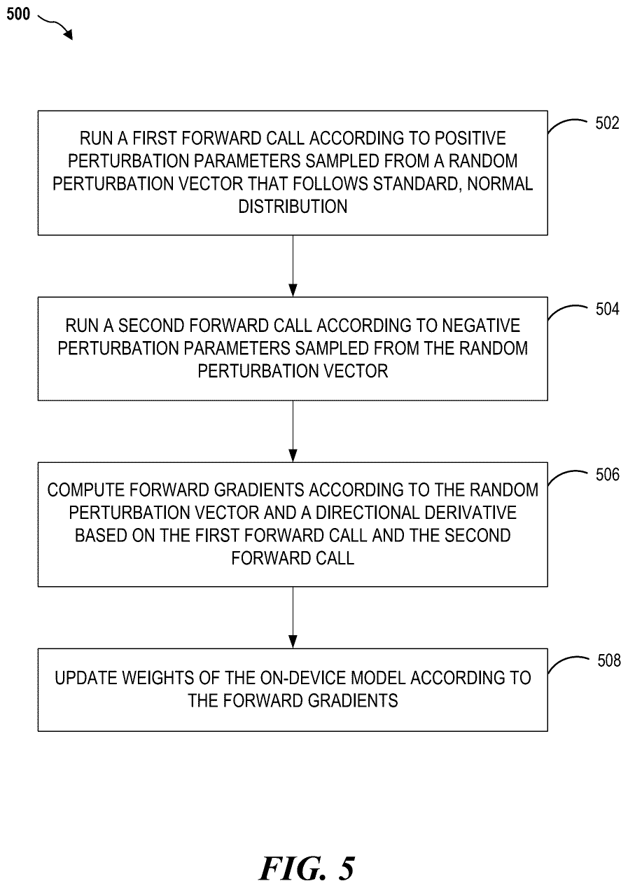

Additionally, the quantized forward gradients for model training and adaptation described herein utilizes fixed-point training, which is distinct from the floating-point precision used for traditional model training. Utilizing fixed-point training further reduces the memory specifications, while enabling model training for memory constrained devices that are limited with fixed-point engines. According to various aspects of the present disclosure, for models with 16-bit weights and 8-bit activation (W16A8) quantization, an 8-bit forward gradient would be sufficient for model convergence and accuracy preservation. A process for a fixed-point, forward-forward on-device model training is described, for example, in FIG. 5

FIG. 5 is a flow diagram illustrating an example processor-implemented method 500 for a fixed-point, forward-forward on-device model training, in accordance with various aspects of the present disclosure. The processor-implemented method 500 begins at block 502, in which a first forward call is run according to positive perturbation parameters sampled from a random perturbation vector that follows standard, normal distribution. At block 504, a second forward call is run according to negative perturbation parameters sampled from the random perturbation vector. At block 506, forward gradients are computed according to the random perturbation vector and a directional derivative based on the first forward call (e.g., loss1) and the second forward call (loss2), for example, as shown in FIGS. 3B and 3C. At block 508, weights of the on-device model are updated according to the forward gradients, for example, as shown in Equation (3) and FIG. 4.

Implementation examples are described in the following numbered clauses:
1. A processor-implemented method for a fixed-point, forward-forward on-device model training/adaptation, comprising:
running a first forward call according to positive perturbation parameters sampled from a random perturbation vector that follows standard, normal distribution;
running a second forward call according to negative perturbation parameters sampled from the random perturbation vector;
computing forward gradients according to the random perturbation vector and a directional derivative based on the first forward call and the second forward call; and
updating weights of the on-device model according to the forward gradients.
2. The processor-implemented method of clause 1, in which computing the forward gradients comprises:
computing the directional derivative according to the first forward call and the second forward call and a perturbation scale; and
multiplying a sign of the directional derivative with the random perturbation vector to generate the forward gradients.
3. The processor-implemented method of clause 1, in which updating the weights comprises performing a quantized stochastic gradient descent (SGD) process.
4. The processor-implemented method of clause 1, further comprising applying a scaling factor to the forward gradients.
5. The processor-implemented method of any of clauses 1-4, further comprising repeating computing of the forward gradients according to an ‘nFold’ training parameter.
6. The processor-implemented method of clause 5, in which the ‘nFold’ training parameter comprises a dynamic schedule training parameter to perform a loss landscape sharpness analysis.
7. The processor-implemented method of clause 1, in which updating of the weights is performed on a subset of the weights of the on-device model.
8. The processor-implemented method of clause 1, in which the on-device model comprises a fixed-point inference accelerator.
9. The processor-implemented method of clause 1, in which updating of the weights comprises re-scaling a norm of the weights.
10. The processor-implemented method of any of clauses 1-9, in which running the first forward call comprises generating a first loss value.
11. The processor-implemented method of clause 10, in which running the second forward call comprises generating a second loss value, in which the directional derivative is based on the first loss value and the second loss value.
12. The processor-implemented method of any of clauses 1-10, further comprising guiding a sampling from the random perturbation vector according to a momentum.
13. The processor-implemented method of any of clauses 1-12, further comprising performing fixed-point, forward-forward on-device model training using a non-continuous loss.
14. An apparatus, comprising:
at least one memory; and
at least one processor coupled to the at least one memory, the at least one processor configured to:
   run a first forward call according to positive perturbation parameters sampled from a random perturbation vector that follows standard, normal distribution;
   run a second forward call according to negative perturbation parameters sampled from the random perturbation vector;
   compute forward gradients according to the random perturbation vector and a directional derivative based on the first forward call and the second forward call; and
   update weights of the on-device model according to the forward gradients.
15. The apparatus of clause 14, in which to computing the forward gradients, the processor is further configured to:
compute the directional derivative according to the first forward call and the second forward call and a perturbation scale; and
multiply a sign of the directional derivative with the random perturbation vector to generate the forward gradients.
16. The apparatus of clause 14, in which to update the weights, the processor is further configured to perform a quantized stochastic gradient descent (SGD) process.
17. The apparatus of clause 14, in which the at least one processor is further configured to apply a scaling factor to the forward gradients.
18. The apparatus of any of clauses 14-17, in which the at least one processor is further configured to repeat the computing of the forward gradients according to an ‘nFold’ training parameter.
19. The apparatus of clause 18, in which the ‘nFold’ training parameter comprises a dynamic schedule training parameter to perform a loss landscape sharpness analysis.
20. The apparatus of clause 14, in which to update the weights the processor is further configured to perform the update on a subset of the weights of the on-device model.
21. The apparatus of clause 14, in which the on-device model comprises a fixed-point inference accelerator.
22. The apparatus of clause 14, in which to update the weights the processor is further configured to re-scale a norm of the weights.
23. The apparatus of any of clauses 14-22, in which to run the first forward call the processor is further configured to generate a first loss value.
24. The apparatus of clause 23, in which to run the second forward call the processor is further configured to generate a second loss value, in which the directional derivative is based on the first loss value and the second loss value.
25. The apparatus of any of clauses 14-24, in which the at least one processor is further configured to guide a sampling from the random perturbation vector according to a momentum.
26. The apparatus of any of clauses 14-25, in which the at least one processor is further configured to perform fixed-point, forward-forward on-device model training using a non-continuous loss.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such with cache and/or general register files. Although the various components discussed may be described as having a specific location, such as a local component, they may also be configured in numerous ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the application and the overall design constraints imposed on the overall system.

The machine-readable media may comprise several software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A processor-implemented method for forward-forward on-device model training/adaptation, comprising:
running a first forward call according to positive perturbation parameters sampled from a random perturbation vector that follows standard, normal distribution;
running a second forward call according to negative perturbation parameters sampled from the random perturbation vector;
computing forward gradients according to the random perturbation vector and a directional derivative based on the first forward call and the second forward call; and
updating weights of the on-device model according to the forward gradients.

2. The processor-implemented method of claim 1, in which computing the forward gradients comprises:
computing the directional derivative according to the first forward call and the second forward call and a perturbation scale; and
multiplying a sign of the directional derivative with the random perturbation vector to generate the forward gradients.

3. The processor-implemented method of claim 1, in which updating the weights comprises performing a quantized stochastic gradient descent (SGD) process.

4. The processor-implemented method of claim 1, further comprising applying a scaling factor to the forward gradients.

5. The processor-implemented method of claim 1, further comprising repeating computing of the forward gradients according to an ‘nFold’ training parameter.

6. The processor-implemented method of claim 5, in which the ‘nFold’ training parameter comprises a dynamic schedule training parameter to perform a loss landscape sharpness analysis.

7. The processor-implemented method of claim 1, in which updating of the weights is performed on a subset of the weights of the on-device model.

8. The processor-implemented method of claim 1, in which the on-device model comprises a fixed-point inference accelerator.

9. The processor-implemented method of claim 1, in which updating of the weights comprises re-scaling a norm of the weights.

10. The processor-implemented method of claim 1, in which running the first forward call comprises generating a first loss value.

11. The processor-implemented method of claim 10, in which running the second forward call comprises generating a second loss value, in which the directional derivative is based on the first loss value and the second loss value.

12. The processor-implemented method of claim 1, further comprising guiding a sampling from the random perturbation vector according to a momentum.

13. The processor-implemented method of claim 1, further comprising performing forward-forward on-device model training using a non-continuous loss.

14. An apparatus, comprising:
at least one memory; and
at least one processor coupled to the at least one memory, the at least one processor configured to:
run a first forward call according to positive perturbation parameters sampled from a random perturbation vector that follows standard, normal distribution;
run a second forward call according to negative perturbation parameters sampled from the random perturbation vector;
compute forward gradients according to the random perturbation vector and a directional derivative based on the first forward call and the second forward call; and
update weights of the on-device model according to the forward gradients.

15. The apparatus of claim 14, in which to computing the forward gradients, the processor is further configured to:
compute the directional derivative according to the first forward call and the second forward call and a perturbation scale; and
multiply a sign of the directional derivative with the random perturbation vector to generate the forward gradients.

16. The apparatus of claim 14, in which to update the weights, the processor is further configured to perform a quantized stochastic gradient descent (SGD) process.

17. The apparatus of claim 14, in which the at least one processor is further configured to apply a scaling factor to the forward gradients.

18. The apparatus of claim 14, in which the at least one processor is further configured to repeat the computing of the forward gradients according to an ‘nFold’ training parameter, in which the ‘nFold’ training parameter comprises a dynamic schedule training parameter to perform a loss landscape sharpness analysis.

19. The apparatus of claim 14, in which the on-device model comprises a fixed-point inference accelerator.

20. The apparatus of claim 14, in which to run the first forward call the processor is further configured to generate a first loss value and to run the second forward call the processor is further configured to generate a second loss value, in which the directional derivative is based on the first loss value and the second loss value.
